(19) United States
(12) Patent Application Publication
(10) Pub. No.: US 2022/0115805 A1
(43) Pub. Date: Apr. 14, 2022

(54) LABELLING PROFILE FOR MARKING ELECTRICAL INSTALLATIONS AND METHOD FOR PRODUCING LABELLING STRIPS

(71) Applicant: PHOENIX CONTACT GmbH & Co. KG, Blomberg (DE)

(72) Inventors: Alexander Hofmann, Hameln (DE); Albrecht Schierholz, Schieder-Schwalenberg (DE); Kilian Klages, Detmold (DE)

(21) Appl. No.: 17/431,981

(22) PCT Filed: Mar. 3, 2020
(86) PCT No.: PCT/EP2020/055496

§ 371 Date: Aug. 18, 2021

(30) Foreign Application Priority Data
Mar. 5, 2019 (BE) BE2019/5132
Mar. 5, 2019 (DE) 10 2019 202 920.5

(51) Int. Cl. H01R 13/46; H01R 9/26; G09F 3/20; G09F 3/02

(52) U.S. Cl. CPC H01R 13/465; H01R 9/2683; G09F 2003/0202; G09F 3/02; G09F 2003/0201; G09F 3/205

(57) ABSTRACT

The invention relates to a labeling profile for marking electrical installations, comprising a labeling region which has a cover surface to be labeled, and comprising a support region which connects to the labeling region facing away from the cover surface, wherein, when viewed in a cross-section transverse to the longitudinal extension, at least sections of the support region have a smaller width than the labeling region, wherein the labeling profile has a constant cross-section when viewed along its longitudinal extension and wherein the labeling profile has spaced-apart, optically detectable position markers on at least one surface facing away from the cover surface, wherein intermediate regions are formed between the position markers and wherein the position markers have in particular reflective properties which differ from the intermediate regions.

The present invention relates to a labeling profile for marking electrical installations and to a method for producing labeling strips for an electrical installation using such a labeling profile.

When producing labels for electrical installations, e.g., for marking terminal blocks in a control cabinet, the problem is that of producing and mounting the labels as efficiently as possible.

When printing on labeling profiles provided as continuous material, it should be ensured, for example, that the slippage and/or deviations in the feed rate or in the feed speed, when the labeling material is fed and passed through the printer, can be corrected so as to achieve a high level of printing accuracy even over longer printing lengths. In particular, this represents a particular problem in the case of a non-divided labeling profile which has no predetermined separation points or is segmented in the longitudinal direction.

Against this background, the technical problem addressed by the present invention is that of providing a labeling profile and a method for producing labeling strips which at least partially or completely solves the aforementioned problem. The problem is solved by a labeling profile according to claim 1 and a method according to claim 5. Further embodiments of the invention can be found in the dependent claims and the following description.

According to a first aspect, the invention relates to a labeling profile for labeling electrical installations, comprising a labeling region which has a cover surface to be labeled, and comprising a support region which connects to the labeling region facing away from the cover surface, wherein, when viewed in a cross-section transverse to the longitudinal extension, at least sections of the support region have a smaller width than the labeling region, wherein the labeling profile has a constant cross-section when viewed along its longitudinal extension and wherein the labeling profile has spaced-apart, optically detectable position markers on at least one surface facing away from the cover surface, wherein the position markers intermediate regions are formed between the position markers and wherein the position markers have in particular reflective properties which differ from the intermediate regions.

The position markers are used to determine the relative position of the labeling profile to a printer, such as a label printer or the like. In this way, the relative position of the labeling profile—which can be provided as continuous material, for example—with respect to a print head can be detected in order to achieve a high level of printing accuracy even over longer printing lengths.

“Optically detectable position marker” means in the present case that the position marker can be detected by an optical detector, such as a light sensor, a light barrier, or the like.

A position marker can be formed by one or more recesses or holes or a perforation.

Another embodiment of the labeling profile is characterized in that the position markers are formed by a plurality of regions that are spaced apart in the longitudinal extension and are reflective to a limited extent and/or transparent to a limited extent, the regions that are reflective to a limited extent and/or transparent to a limited extent being formed in particular by a black or dark coloration. The position markers can be so-called black marks.

For example, local coloring and/or laminating and/or coating can be used to create a particular position marker that can be detected by an optical sensor.

Alternatively or in addition, a particular position marker that can be detected by an optical sensor can be created by providing an at least partially transparent region which is surrounded by intermediate regions that are less transparent than the position mark.

Alternatively or in addition, a particular position marker that can be detected with an optical sensor can be created by coating or irradiating in order to change the material properties locally in a detectable manner.

In order to be compact and yet reliably detectable, a position marker can have a length measured in the longitudinal extension of 4 mm or more. Alternatively or in addition, a position marker can have a height measured transversely to the longitudinal extension of 3 mm or more.

A particular position marker can be provided over the cover surface itself or on a surface facing away from the cover surface.

In order to achieve a high level of printing accuracy, the position markers, when viewed in the longitudinal extension, can have a spacing of 20 mm or more, in particular have a spacing of 30 mm or more, in particular have a spacing of 30 mm.

The position markers can be arranged at regular intervals or unevenly distributed. The position markers are preferably arranged at regular intervals.

The labeling profile can have an extruded plastics profile or consist of an extruded plastics profile.

A plastics material of the plastics profile can have a Shore hardness in a range from 84A to 54D. A plastics material of the plastics profile can have a Shore hardness in a range from 75A to 70D. A plastics material of the plastics profile can have a Shore hardness in a range from 75A to 60D (Shore hardness according to DIN ISO 7619-1 (3s)). The plastics profile thus has sufficient flexibility to be deformed and labeled within a label printer, such as a thermal transfer printer or the like, between a print roller and a print head. On the other hand, the plastics profile offers the necessary rigidity to be form-fittingly locked reliably and in a dimensionally stable manner within a receptacle. For this purpose, molded elements can be provided, for example, laterally projecting webs, when viewed transversely to a longitudinal extension, which engage in undercuts or a groove of a receptacle.

According to a further embodiment of the labeling profile, the plastics profile is a solid profile. This means that the plastics profile, when viewed in a cross-section, consists of solid material and has no cavities or chambers. In this way, a dimensionally stable labeling profile can be provided in a simple and reliable manner.

Alternatively, the plastics profile of the labeling profile can be a hollow profile. This means that, when viewed in a cross-section, the plastics profile has a cavity which is delimited by the plastics material of the plastics profile. In this way, a light labeling profile can be produced using less material, which is thus cost-effective to manufacture.

Alternatively, the plastics profile of the labeling profile, when viewed in a cross-section, can be shaped like a C-profile, wherein the labeling region and the molded element are connected by a web. Such a C-profile has the advantages already mentioned for the hollow profile, i.e., that a light labeling profile can be produced cost-effectively and using less material. The C-profile also has the advantage that it is more flexible than the hollow profile, for example.

If the labeling profile has a plastics profile made of solid material or a hollow profile, the plastics profile can be designed with mirror symmetry when viewed in a cross-section.

If the plastics profile of the labeling profile is shaped like a C-profile, the plastics profile can have an asymmetrical shape when viewed in a cross-section, wherein, for example, a web connecting the labeling region and the molded element is arranged on one side at an offset to a center plane of the plastics profile.

When viewed in a cross-section, the labeling region can be curved; in particular, it has a convex shape. The outwardly curved shape allows the surface to be labeled or the labeling region to be clamped in a printer.

The labeling region, when viewed in a cross-section, can have a width in a range from 8 mm or more to 11 mm or less; in particular, the labeling region, when viewed in a cross-section, has a width of 10.8 mm or 10.5 mm.

Alternatively or in addition, the labeling profile, when viewed in a cross-section, can have a height in a range from 2 mm or more to 6 mm or less; in particular, the labeling profile, when viewed in a cross-section, has a height of 3 mm or 4.2 mm or 4.4 mm.

Alternatively or in addition, the labeling region, when viewed in a cross-section, can have a thickness in a range from 0.3 mm or more to 2 mm or less; in particular, the labeling region, when viewed in a cross-section, has a thickness of 1.1 mm or less 0.5 mm or 0.9 mm.

Alternatively or additionally, the molded element, when viewed in a cross-section, can have a thickness in a range from 0.5 mm or more to 2 mm or less; in particular, the molded element, when viewed in a cross-section, has a thickness of 1 mm.

The labeling profile can therefore be dimensioned in the fully mounted state, depending on the mounting and installation space requirements.

The support region of the labeling profile can have a foam layer or consist of a foam layer, wherein the foam layer has a foamed material that is integrally bonded to the cover layer.

The foam layer can be compressed during the labeling or printing of the cover layer, for example, with the aid of a thermal transfer printer, in order to achieve sufficient stability during the printing process. In the relaxed, non-compressed state of the foam layer, a spacing is formed between the molded element and the cover layer, such that the molded element can be inserted into an undercut or groove, for example, and fastened in a form-fitting manner.

According to further embodiments, alternatively or in addition to a form-fitting and/or force-fitting fastening, the labeling profile can be glued to a component, such as a terminal block or a support rail module.

The labeling profile can have one or more adhesive layers. The one or more adhesive layers can each be covered by a protective layer which can be peeled off prior to mounting in order to expose the adhesive layer.

According to a second aspect, the invention relates to a method for producing labeling strips for an electrical installation, comprising the following method steps: providing a labeling profile, wherein the labeling profile is designed according to the invention; feeding the labeling profile to a label printer; labeling the cover surface; assembling and/or perforating the labeling profile to form at least one labeling strip to a predefined length; wherein at least two or more position markers of the labeling profile are optically detected before, during or after the labeling, wherein in particular a relative position of the labeling profile to a print head of the label printer is determined on the basis of the detected position markers.

A high level of printing accuracy can be achieved with the aid of the position markers, in particular in the event that the labeling profile is provided as a continuous material and a plurality of labeling strips are produced in succession.

The cover surface can first be labeled for a plurality of labeling strips in a continuous printing process, such that the cover surface is provided with the labeling for two or more, three or more, or a plurality of labeling strips, for example, in a continuous printing process.

The labeling profile is then assembled and/or perforated to form the labeling strips to a predefined length in each case. The labeling strips can be the same length or have different lengths. In particular, an individual length can be predefined for each labeling strip.

In order to achieve a high level of printing accuracy even over long printing lengths, according to a further embodiment of the method a feed speed of the labeling profile into the label printer and/or a print head movement of the label printer is adapted on the basis of the detected position markers.

According to a further embodiment of the method, alternatively or additionally, assembly and/or perforation of the labeling strip can also be adapted on the basis of the detected position markers, wherein the length of the labeling strip is adapted on the basis of the detected position markers, in order to achieve a high level of printing accuracy even over long printing lengths.

If a printer used, in particular a label printer, has a tolerance of +1% at a spacing of 30 mm between the position markers in the feed or longitudinal direction of the labeling profile at a constant feed rate, i.e., the print feed rate is too high, the labeling strip to be subsequently produced is stretched accordingly by 0.3 mm. If a printer used, in particular a label printer, has a tolerance of −1% at a spacing of 30 mm between the position markers in the feed or longitudinal direction of the labeling profile at a constant feed rate, i.e., the print feed rate is too low, the labeling strip to be subsequently produced is shortened accordingly by 0.3 mm.

Such a length compensation described above can be calculated and carried out distributed over a plurality of successive labeling strips.

Accordingly, a further embodiment of the method can be characterized in that a plurality of labeling strips are produced from the labeling profile, wherein the length of a first labeling strip and/or the length of a second labeling strip is increased or decreased if a deviation in the feed speed has been detected on the basis of the detected position markers, in particular if the feed speed is set to be constant.

A print roller of a printer can be profiled in order to reliably support and guide the labeling profile.

The invention is described in greater detail in the following with reference to drawings showing embodiments, in which, schematically:

FIG. 1 shows a labeling profile according to the invention in a perspective view;

FIG. 2 shows the labeling profile from FIG. 1 in a view from below;

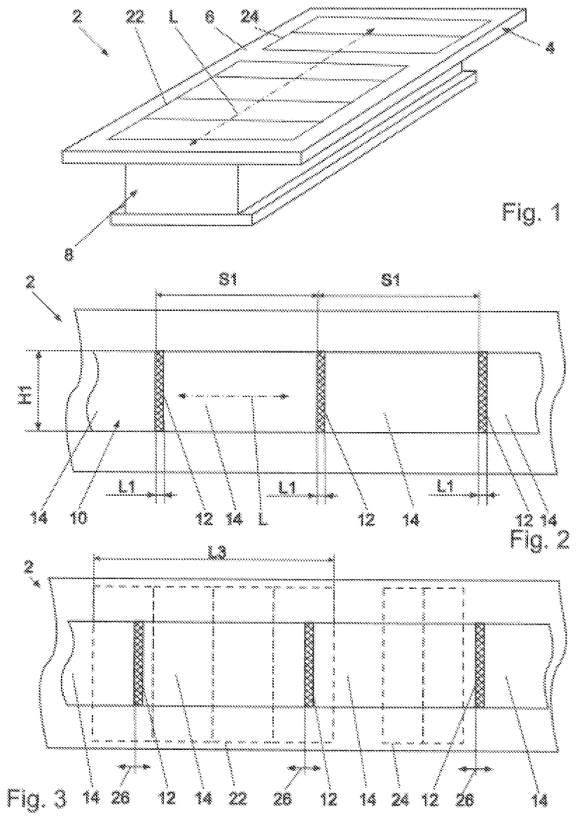

FIG. 3 shows the labeling profile from FIG. 1 in a further view from below;

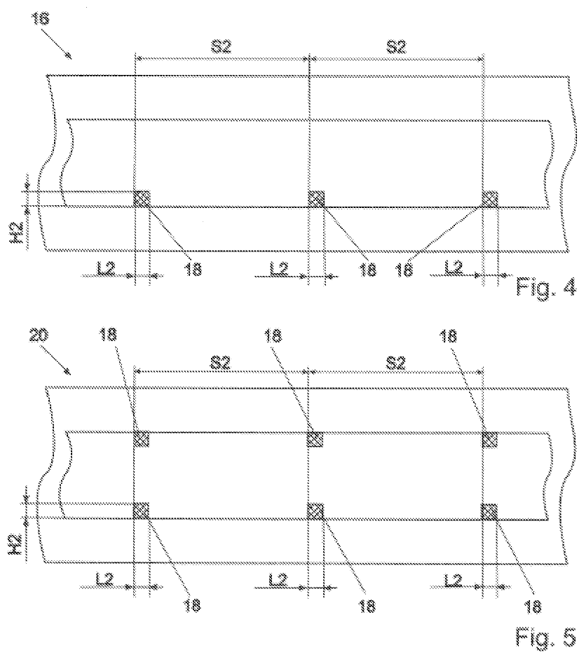

FIG. 4 shows another variant of a profile according to the invention in a view from below;

FIG. 5 shows another variant of a profile according to the invention in a view from below.

FIG. 1 shows a labeling profile 2 for marking electrical installations. The labeling profile 2 has a labeling region 4 which has a cover surface 6 to be labeled.

The labeling profile 2 has a support region 8 which connects to the labeling region 4 facing away from the cover surface 6. As can be seen from FIG. 1, when viewed in a cross-section transverse to the direction of longitudinal extension L, at least sections of the support region 8 have a smaller width than the labeling region 4.

The labeling profile 2 is provided to a printer as a continuous material.

The labeling profile 2 has a constant cross-section when viewed along its longitudinal extension. This means that the labeling profile 2 is not pre-assembled by predetermined breaking points or the like and has no molded notches that would predefine a longitudinal division.

The labeling profile 2 has spaced-apart, optically detectable position markers 12 on a surface 10 facing away from the cover surface 6. Intermediate regions 14 are formed between the position markers 12, wherein here the position markers 12 have reflective properties which differ from those of the intermediate regions 14.

In the present case, the position markers 12 are formed by a plurality of regions 12 that are spaced apart in the longitudinal extension L and are reflective to a limited extent. The position markers 12 are formed by locally coloring the labeling profile 2 consisting of plastics material.

In the present case, a particular position marker 12 has a length L1 measured in the longitudinal extension L of 4 mm. A particular position marker 12 has a height H1 measured transversely to the longitudinal extension L of 20 mm. The position markers 12, when viewed in the longitudinal extension L, are spaced 30 mm apart. The spacing S1 is thus 30 mm.

FIGS. 4 and 5 show further embodiments of labeling profiles according to the invention, wherein only the differences from the embodiment described above are discussed in order to avoid repetition.

The embodiment of a labeling profile 16 shown in FIG. 4 differs from the embodiment described above in that position markers 18 are provided, the height H2 of which is only 3 mm. The length L2 in the present case is 4 mm. According to the further variant of a labeling profile 20, such position markers 18 are arranged in two rows.

To produce a labeling strip for an electrical installation, a labeling profile 2, 16, 20 is first provided.

The labeling profile 2, 16, 20 is fed to a printer (not shown). Inside the printer, the cover surface 6 is labeled in the region of the printing regions 22, 24.

Subsequently, the particular labeling profile is assembled or cut to length to form at least one, two, or more labeling strips, where, for example, a predefined length L3 is cut to length from the labeling profile 2 for the printing region 22 provided for a first labeling strip.

The respective position markers 12, 18 are optically detected before, during or after the labeling.

In the present case, a plurality of labeling strips are produced from a particular labeling profile 2, 16, 20, wherein the length of a first labeling strip and/or the length of a second labeling strip is increased or decreased if a deviation in the feed speed of the printer has been detected on the basis of the detected position markers, in particular if the feed speed is set to be constant. The correction of the length is indicated by the arrows 26.

1. Labeling profile for marking electrical installations,
comprising a labeling region which has a cover surface to be labeled,
and comprising a support region which connects to the labeling region facing away from the cover surface,
wherein, when viewed in a cross-section transverse to the longitudinal extension, at least sections of the support region have a smaller width than the labeling region,
wherein the labeling profile has a constant cross-section when viewed along its longitudinal extension and
wherein the labeling profile has spaced-apart, optically detectable position markers on at least one surface facing away from the cover surface,
wherein intermediate regions are formed between the position markers, and
wherein the position markers have in particular reflective properties which differ from the intermediate regions.

2. Labeling profile according to claim 1, characterized in that
the position markers are formed by a plurality of regions that are spaced apart in the longitudinal extension and are reflective to a limited extent and/or transparent to a limited extent,
the regions that are reflective to a limited extent and/or transparent to a limited extent being formed in particular by a black or dark coloration.

3. Labeling profile according to claim 1,
characterized in that
a position marker
has a length measured in the longitudinal extension of 4 mm or more and/or
has a height measured transversely to the longitudinal extension of 3 mm or more.

4. Labeling profile according to claim 1, characterized in that
the position markers, when viewed in the longitudinal extension, have a spacing of 20 mm or more, in particular have a spacing of 30 mm or more, in particular have a spacing of 30 mm.

5. Method for producing labeling strips for an electrical installation, comprising the following method steps:
providing a labeling profile, wherein the labeling profile is designed according to claim 1;
feeding the labeling profile to a printer, in particular a label printer;
labeling the cover surface;
assembling and/or perforating the labeling profile to form at least one labeling strip to a predefined length;
wherein at least two or more position markers of the labeling profile are optically detected before, during or after the labeling, wherein in particular a relative position of the labeling profile to a print head of the printer is determined on the basis of the detected position markers.

6. Method according to claim 5, characterized in that
a feed speed of the labeling profile into the label printer and/or a print head movement of the label printer is adapted on the basis of the detected position markers; and/or
assembly and/or perforation of the labeling strip is adapted on the basis of the detected position markers, the length of the labeling strip being adapted on the basis of that of the detected position markers.

7. Method according to claim 5, characterized in that
a plurality of labeling strips are produced from the labeling profile,
the length of a first labeling strip and/or the length of a second labeling strip being increased or decreased if a deviation in the feed speed has been detected on the basis of the detected position markers, in particular if the feed speed is set to be constant.
